(19) United States
(12) Patent Application Publication
(10) Pub. No.: US 2011/0155406 A1
(43) Pub. Date: Jun. 30, 2011

(54) PNEUMATIC DRILL DEVICE

(76) Inventors: Julien Poncet, Comtal (FR); Alain Mucig, Chaponost (FR)

(21) Appl. No.: 12/864,922

(22) PCT Filed: Jan. 30, 2009
(86) PCT No.: PCT/FR09/50136

§ 371 Date: Oct. 6, 2010

(30) Foreign Application Priority Data
Jan. 31, 2008 (FR) 0800528

(51) Int. Cl. B23B 45/04

(52) U.S. Cl. 173/169

(57) ABSTRACT

Pneumatic drill device comprising an outer casing, an assembly of a cylinder and a movable piston actuating a pick element, a device for supplying the cylinder with compressed air, an air exhaust device and an operational control device, wherein the outer casing is formed from two complementary sections adapted to fit into one another in order to enclose, in addition to the cylinder and piston assembly, the said devices for supplying the cylinder, for air exhaust and for operational control.

Pneumatic drills with metal bodies are known, which are generally heavy and comprise an operating handle attached to the body.

Owing to their size and weight, these drills do not lend themselves to finish drilling or drilling where there is limited access. Moreover, the air exhaust is evacuated radially onto the cylinder, and this may interfere with the gripping of the cylinder of the apparatus by the user.

The invention proposes a pneumatic drill device comprising an outer casing, an assembly of a cylinder and movable piston operating a pick element, a device for supplying the cylinder with compressed air, an air exhaust device and an operational control device, characterised in that the outer casing is formed from two complementary sections adapted to fit into one another in order to enclose, in addition to the cylinder and piston assembly, the cylinder supply device, the air exhaust device and the operational control device, and in that at least one channel of the supply device and/or of the exhaust device is formed in at least one of the casing sections, this channel being formed laterally within the thickness of the casing section, parallel to the cylinder.

The enclosed supply, exhaust and control devices are advantageously rigidly trapped between the said casing sections, which are clamped against one another in sealed manner.

The casing sections are adapted in shape so as to house the enclosed devices within their linked portion, the devices thus being “sandwiched” between the two assembled casing sections.

They advantageously comprise at least one layer of material adapted to insulate vibrations and operating noise from the cylinder and piston assembly.

They are advantageously formed by moulding or injection of synthetic materials, for example plastics, and preferably adapted to the use of a small lightweight drill device, preferably using compressed air at low pressure, for example 0.5 to 2.5 bar, for finish drilling or drilling with limited access.

At least one channel of the supply device and/or of the exhaust device may be formed in at least one of the casing sections, thus avoiding the need for external tubing.

The casing sections are advantageously two plastic half-shells which are substantially symmetrical with one another in relation to a longitudinal median plane of the drill device and are adapted to be clamped against one another in sealed manner, for example by a set of screws arranged around their periphery. The two casing sections can thus easily be replaced in the event of wear or breakage.

Their sealed assembly is advantageously provided by means of a peripheral bead around one of the parts, which is squeezed when clamped in a corresponding groove in the other part, optionally onto a flexible joint.

The casing sections are advantageously formed with at least one operating handle for the pneumatic drill device which incorporates the operational control device (control trigger).

The said handle may be offset from the axis of the cylinder and be in the shape of a D one branch of which, the front branch, which is distinct from the rear main branch, protects the operator's hand.

The said front branch of the handle may house at least part of the air exhaust device (for example a baffle), which vents out of the cylinder, for example at the outer end of the handle, without interfering with the operators hand.

The main branch for operating the handle may also incorporate the connection for the supply tubing at its outer end and a supply valve connected to the control member (control trigger).

The front end part of the casing sections, opposite the handle, may also house at least one other air exhaust portion (air exhaust baffle) which vents towards the pick element and hence without impeding the handling of the casing.

In addition, an internal shaping is provided in the casing sections for collecting any air leaks from the enclosed devices and directing them towards the air exhaust device (leaks from the connections in particular).

The invention is illustrated hereinafter by means of an exemplifying embodiment and with reference to the appended drawings, wherein:

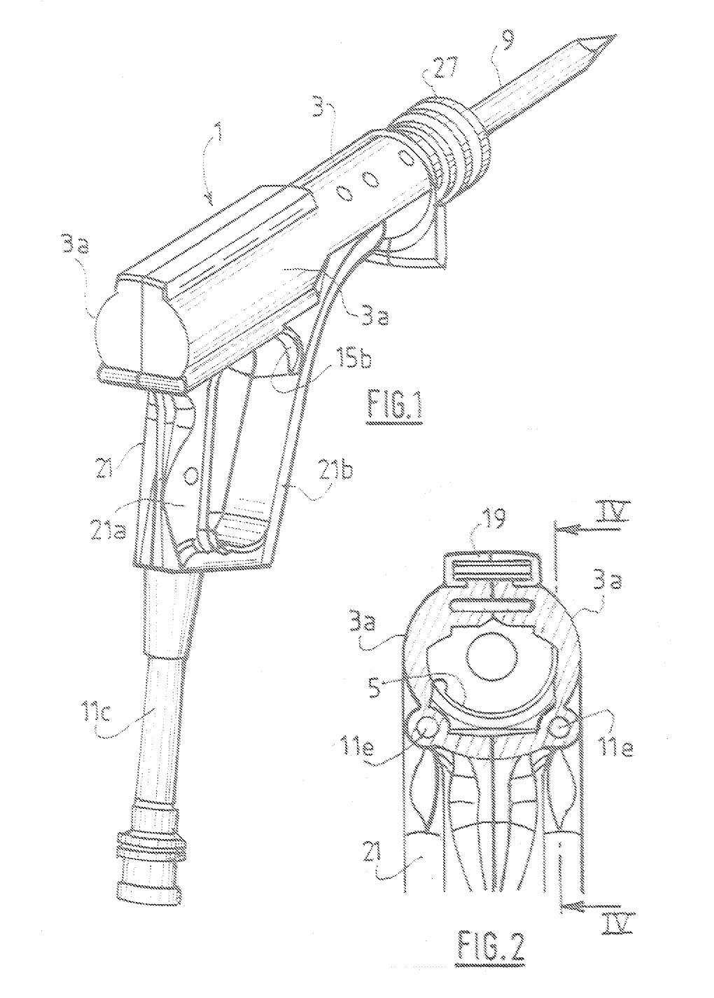

FIG. 1 is a perspective view of a pneumatic drill device according to the invention,

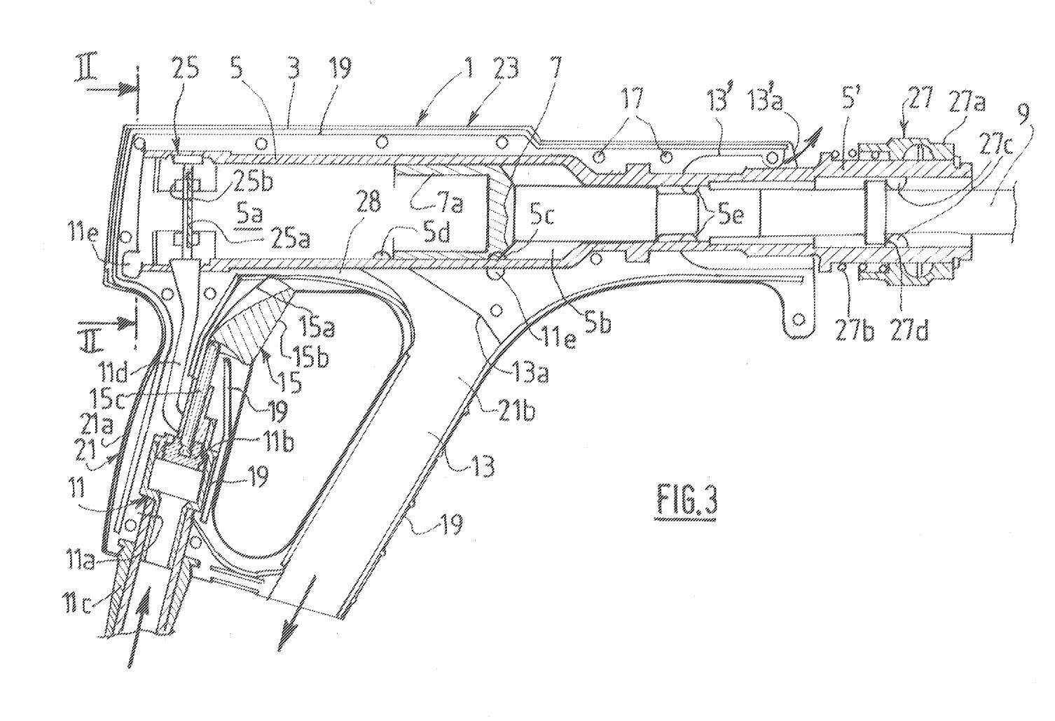

FIG. 2 is a partial cross-section through the pneumatic drill device on the line 2-2 in FIG. 3,

FIG. 3 is an enlarged axial section through the pneumatic drill device,

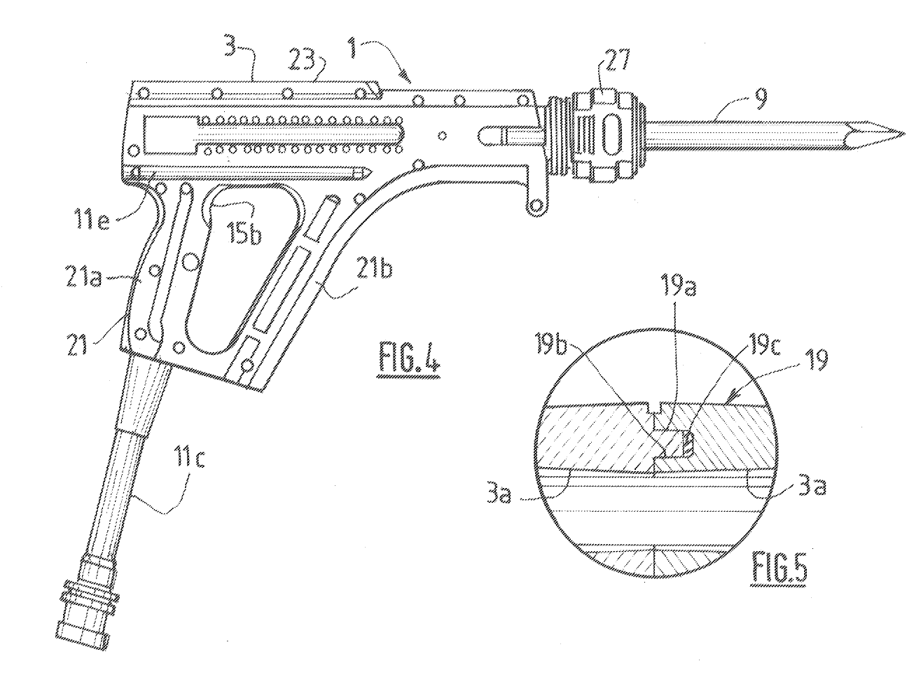

FIG. 4 is a longitudinal section on the line 4-4 in FIG. 2 showing the supply relief channels for the pneumatic drill device, and

FIG. 5 is an enlarged partial cross-section showing the attachment of the half-shells of the casing.

Referring to the drawings, particularly FIGS. 1 and 3, the pneumatic drill device 1 according to the invention comprises an outer casing 3, an assembly of a cylinder 5 and movable piston 7 operating a pick element 9, a device 11 for supplying the cylinder 5 with compressed air, an air exhaust device 13 and an operational control device 15.

The outer casing 3 comprises two half-shells 3a attached to one another along a median longitudinal plane of the device, clamped against one another by means of screws 17 provided around their periphery.

These half-shells 3a, produced as plastic mouldings, contain the supply device 11, the exhaust device 13 and the control device 15 for the drill device, trapping them rigidly in corresponding housings 11a, 13a, 15a, respectively, formed during the assembling thereof. They are assembled in sealed manner with one another by means of a peripheral joint 19 consisting of a peripheral bead 19a on one half-shell which is squeezed when clamped in a complementary groove 19b on the other half-shell (FIG. 5) and optionally bears on a flexible joint 19c in the base of the groove. The half-shells 3a are formed with the operating handle 21 of the pneumatic drill device, which comprises the control member or control trigger 15b of the pneumatic drill device mounted on a main rear branch 21a of the handle of the device (opposite the pick element 9) protected by a front branch 21b connected to the earlier one, thereby forming a D, axially offset from the cylinder 5.

The assembly of the cylinder 5 and piston 7 extends axially substantially along the length of the body 23 of the drill device. In conventional manner the cylinder 5 houses in its rear portion the compressed air distribution portion 25 which is connected to the compressed air supply device 11 mounted in the main branch 21 a of the handle, and it comprises in its front portion the engaging portion of the pick element 9 or advancer 27 mounted on ball bearings. The latter is formed in an enlarged front axial extension 5′ of the cylinder, comprising in conventional manner a ring 27a movably mounted on its surface, biased forwards by a spring 27b and retaining the pick element 9 by means of ball bearings 27c trapped in recesses 27d, this ring 27a being adapted to retract when pushed by the operator counter to the spring 27b in order to release the pick element 9.

The piston 7 is hollow, and slidably mounted in the cylinder 5, this piston being adapted to be pushed abruptly towards the pick element 9 under the pressure of the compressed air in the cylinder 5 and on its hollow head 7a, to subject it to impact and allow the drill device to act as a pick.

The supply device 11 for the cylinder comprises a supply valve 11b located on the extension of the main branch 21a of the handle, which is itself connected to a tube 11c for supplying compressed air at about 2 bars at its outer end. This valve 11b is connected to the trigger 15b by a control rod 15c. The latter, when closed, without actuation of the trigger, opens a supply channel 11d for compressed air to the distribution portion 25 under the operation of the control trigger 15b.

The distribution portion 25 is conventional and comprises a pad 25a mounted to be movable back and forth on its seat 25b and alternately distributing the compressed air into the upper chamber 5a of the cylinder with the aim of pushing the piston 7 towards the pick element 9 or, conversely, supplying the lower part 5b of the cylinder via relief control channels 11e for the piston (shown in FIGS. 2 and 4) for pushing the latter towards the upper part 5a of the cylinder (in the opposite direction to the pick or drill element).

There are two of the relief channels 11e mentioned above (there may be from one to several and of variable section, depending on the space available in the casing) each formed laterally within the thickness of the half-shells 3a, parallel to the cylinder 5 and at the lower level of the latter. These channels 11e are connected to the distribution portion 25, to its rear end and to the cylinder via holes 5c opening out at its lower portion 5b.

The exhaust device comprises a main part 13 housed in the front branch 21b of the handle, which is in the shape of a baffle for channelling the compressed air, linked via holes 5d to the cylinder 5 and open at the end of this branch. These baffles extend longitudinally in the space within the branch 21b of the handle. They allow compressed air to be evacuated to the outer end of the handle without inconveniencing the operator. Another part of the exhaust device 13′ is arranged in the front end portion of the half-shells 3a, opposite the handle 21. This portion comprises small baffles connected to the lower part 5b of the cylinder via through-holes 5e and is connected to the outside of the half-shells 3a via holes 13′a opening outwards towards the pick element 9.

It should be noted that internal shaping of the half-shells 3a may be provided close to the distribution portion 25 and the control trigger 15b, in a small space 28 around the cylinder 5, and guide residual leaking air (which is unavoidable) to the main exhaust part 13.

The operation of the pneumatic drill device according to the invention will now be described with reference to FIG. 3.

The compressed air comes from the open supply valve 11b (as indicated by the arrow), with the trigger 15b actuated, towards the distribution portion 25. Depending on the position of the movable pad 25a, the compressed air is conveyed either into the upper chamber 5a of the cylinder to push the piston 7 towards the pick element 9 with a striking action, or it is guided in the opposite direction, to the end of the distribution portion 25, to arrive via the two relief channels 11e at the lower level 5b of the cylinder and allow the piston 7 to move up in order to be struck again, in the conventional mode of operation of a pneumatic drill.

Thus, let us suppose that the piston 7 is in the top position in the cylinder 5 (close to the distribution portion 25), the pad 25a being pressed onto its seat 25b to the left, and closing off the relief channels 11e, the compressed air then travels directly into the upper cylinder chamber 5a and abruptly drives back the piston 7 which is moved past the exhaust holes 5d of the main exhaust portion 13. At this level, the pressure in the upper chamber 5a drops to the level of atmospheric thrust or thereabouts, while the air in the upper chamber is evacuated through the main exhaust portion 13. At the same time, the air cushion compressed by the arrival of the piston 7 between the pick element 9 and the piston 7 is evacuated through the front exhaust portion 13′ towards the pick element 9, thus preventing the piston from being slowed down by this air cushion as it travels towards the pick element 9.

The pad 25a is thus moved to the opposite position on its seat 25b, closing off the intake for compressed air into the upper cylinder chamber 5a and opening up access to the relief channels 11e. The compressed air then arrives at the lower level 5b of the cylinder and pushes the piston 7 back up to the upper level 5a of the cylinder for a new striking cycle.

In this embodiment, compressed air at low pressure was used, but it is possible to supply the device with compressed air at high pressure (7 bars, for example) by adapting the cross-sections of the supply, distribution, relief and exhaust passages. The invention thus provides a pneumatic drill device which is simple, can be made in a small size, and is lightweight and economical.

1-14. (canceled)

15. A pneumatic drill device comprising an outer casing, an assembly of a cylinder and movable piston actuating a pick element, a device for supplying the cylinder with compressed air, an air exhaust device and an operational control device, the outer casing being formed from two complementary sections adapted to fit into one another in order to enclose, in addition to the assembly of the cylinder and piston, the said devices for supplying the cylinder, for air exhaust and for operational control, and wherein at least one channel of the supply device and/or of the exhaust device is formed in at least one of the casing sections, the channel being formed laterally within the thickness of the casing section, parallel to the cylinder.

16. The pneumatic drill device according to claim 15, wherein the said enclosed supply, exhaust and control devices are rigidly trapped between the said casing sections which are clamped against one another in sealed manner.

17. The pneumatic drill device according to claim 15, wherein the said casing sections are adapted in shape so as to house, in their linked portion, the said enclosed devices, which are thus sandwiched between the two assembled casing sections.

18. The pneumatic drill device according to claim 15, wherein the said casing sections comprise at least one layer of material adapted to insulate vibrations and operating noise from the assembly of the cylinder and piston.

19. The pneumatic drill device according to claim 15, wherein the said casing sections are formed by moulding of synthetic materials, for example plastics.

20. The pneumatic drill device according to claim 15, wherein the said casing sections are adapted to the use of a small lightweight drill for finish drilling or drilling with limited access.

21. The pneumatic drill device according to claim 15, wherein the said casing sections are two half-shells made of plastics.

22. The pneumatic drill device according to claim 15, wherein the sealed assembly of the casing sections is achieved by means of a peripheral bead on one of the sections which is squeezed when clamped in a corresponding groove on the other section, and optionally onto a flexible joint.

23. The pneumatic drill device according to claim 15, wherein the said casing sections are formed with at least one operating handle of the pick device, which incorporates the operational control device.

24. The pneumatic drill device according to claim 23, wherein the handle is offset from the axis of the cylinder and is in the shape of a “D” one branch of which, the front branch, which is distinct from the rear main branch, protects the operator's hand.

25. The pneumatic drill device according to claim 24, wherein the said front branch of the handle houses at least part of the air exhaust device, which is vented out of the cylinder, for example at the outer end of the handle, without interfering with the operator's hand.

26. The pneumatic drill device according to claim 24, wherein the main branch for operating the handle incorporates a connection for the supply tubing at its outer end and a supply valve connected to the control device.

27. The pneumatic drill device according to claim 15, wherein the front end part of the casing sections also houses at least one other air exhaust portion which vents towards the pick or drill element and hence without impeding the handling of the casing.

28. The pneumatic drill device according to claim 15, wherein an internal shaping is provided in the casing sections for collecting any air leaks from the enclosed devices and directing them towards the air exhaust device.
